(19) United States
(12) Patent Application Publication
(10) Pub. No.: US 2026/0199725 A1
(43) Pub. Date: Jul. 16, 2026

(54) The monitoring system for remote contactless diagnostics and control of automatic fire extinguishing devices for local protection of electrical devices

(71) Applicant: MEGELLAN, SE, Praha 3 - Zizkov (CZ)

(72) Inventor: Marek Duda, Nový Bohumín (CZ)

(73) Assignee: MEGELLAN, SE, Praha 3 - Zizkov (CZ)

(21) Appl. No.: 19/137,424

(22) PCT Filed: Nov. 30, 2023
(86) PCT No.: PCT/CZ2023/000046

§ 371 Date: Jun. 10, 2025

(30) Foreign Application Priority Data
Dec. 16, 2022 (CZ) PV 2022-533

(51) Int. Cl. A62C 37/50; A62C 37/40

(52) U.S. Cl. CPC A62C 37/50; A62C 37/40

(57) ABSTRACT

The monitoring system (1) for remote contactless diagnostics and control of automatic fire extinguishing devices (3) for local protection of electrical devices contains the control centre (2), at least one fire extinguishing device (3) remotely arranged together with at least one protected device (4) in the closed protected space (4.1), wherein at least one fire extinguishing device (3) is arranged at each protected device (4), wherein the IoT type network or similar network is used for the wireless communication between the control centre (2) and at least one fire extinguishing device (3) arranged in the remote closed protected space (4.1) together with the protected device (4), the LAN or similar network of GSM is used for the communication between at least one fire extinguishing device (3) arranged in the closed protected space (4.1) together with the protected device (4) and user (4.0) of the protected device (4).

### FIELD OF THE INVENTION

The invention relates to the remote control of the functionality of fire extinguishing devices that protect electrical devices, especially electrical switchboards of residential houses, family houses, industrial and commercial premises, substations and the like against undesirable temperature increases or flame burning.

### STATE OF THE ART

At the time being, there are available remote contactless electrical appliance operation monitoring systems as well as systems for the remote reading of measuring equipment such as water meters, gas meters and the like.

The subject-matter of the EP 3 241 201 is the system of the remote monitoring of security alarm devices at the installation site whereby the fire detection systems may include heat detectors, CO detectors, smoke detectors and other detectors. These detectors and alarm devices transfer information on possibly rising temperature, occurrence of smoke, i.e. they only transfer the requirement to execute a certain measure, for instance to call the firemen. The system itself cannot lower the temperature of protected devices or extinguish fire.

However, there are no known systems monitoring cooling and extinguishing devices in a closed protected space of protected electrical equipment at the time being.

It is very important to ensure high fire safety with remotely monitored cooling and fire extinguishing equipment.

### SUMMARY OF THE INVENTION

The object of the invention was to create a system for the remote contactless control of the functionality of automatic extinguishing devices, hereinafter referred to as fire extinguishing devices, providing the local protection of the electrical devices including but not limited to all power switchboards, transformer stations and other electrical devices, herein after referred to as protected devices, arranged in a closed protected space wherein at least one fire extinguishing device as a whole is arranged in a closed protected space together with a protected device of the user.

Another fire extinguishing device version is configured on a DIN rail together with the protected device in a switchboard in a closed protected space.

Another object of the solution was the remote monitoring of the space where the protected device is arranged together with the fire extinguishing device-the closed protected space including the inspection whether doors and covers of the closed protected space are closed.

Another object of the solution was the monitoring of possible unscheduled change of the position of the fire extinguishing device.

Another object of the solution was, on the basis of automatically carried out checks of the functionality of the fire extinguishing device remotely, the provision of a protocol on the operability of the fire safety device and its sending via electronic communication.

Another object of the solution was ensuring high security of the entire device.

The principle of the monitoring system for the remote contactless diagnostics and control of the fire extinguishing devices for the local protection of electrical device resides in the fact that the monitoring system contains a control centre that contains a control unit, the first wireless communication module, the first evaluation module, an information module, moreover the monitoring system contains at least one fire extinguishing device, at least one protected device arranged in the closed protected space wherein the fire extinguishing device as a whole is also arranged in the closed protected space. At least one fire extinguishing device is arranged at each protected device.

An IoT (Internet of Things) network or other similar network is used for the wireless communication between the control centre and the fire extinguishing device arranged in a remote closed protected space with a protected device.

Wherein a known fire extinguishing device is used as the basis for the fire extinguishing device that contains an extinguishing medium carrier, used fire extinguishing medium is a chemical gas fire extinguisher corresponding to the relevant standard, wherein the extinguishing medium is under pressure in the carrier, a valve is directly connected to the extinguishing medium carrier, the valve contains a nozzle to release the extinguishing medium from the carrier to the closed protected space, also contains a pressure sensor that monitors the state of the medium in the carrier and contact for connecting of an external power supply. Moreover, the fire extinguishing device contains a temperature sensor that has the same time a function on of a switch and it automatically monitors the temperature of the closed protected space of the protected device. The fire extinguishing device is connected to a battery to which a temperature sensor with a switch function and valve coil winding are connected. If the temperature in the closed protected space rises to the value at which the temperature sensor with the switch function is set, it is switched on. This opens the nozzle of the valve, through which the extinguishing medium from the carrier is released into the closed protected device and cools the increased temperature or extinguishes the flame. The fire extinguishing device is developed for placement in protected device, for example in an electrical switchboard on a DIN rail.

A LAN (Local Area Network) or GSM (Groupe Special Mobile) connection system is used for the communication between the fire extinguishing device arranged in the closed protected device together with the protected device and the user of the protected device.

Wherein the fire extinguishing device contains also new elements-a monitoring processor, the second wireless communication module, the second evaluation unit, the first contact for the connection of the temperature linear cable with a resistor, wherein the temperature linear cable is arranged in the closed protected space, further the fire extinguishing device contains the first temperature sensor, the second temperature sensor, the fifth contact for connecting of the position sensor of the fire extinguishing device, the end switch, universal input, connector and LAN (Local Area Network) chip, the second contact for connecting of a smoke sensor that is arranged in the closed protected space, the third contact for connecting of the external power supply, the fourth contact for connecting of the door sensor of the closed protected space and to increase the level of the safety of the fire extinguishing device it contains a temperature glass ampoule as a passive temperature sensor that is connected to the fire extinguishing medium carrier in such a way that it is partially embedded in the carrier, for example screwed. The temperature glass ampoule is made for a certain given temperature that is already beyond the limits of desirable values from the point of safety of the protected space. This temperature is set to a higher level than the set temperature of electronic elements, namely the temperature sensors. In the case the ambient temperature rises above this limit in the closed protected space of the protected device and none of the safety elements has been activated, the temperature glass ampoule bursts and the fire extinguishing medium is released from the carrier to the closed protected space in order to decrease the temperature or extinguish flames. The extinguishing function of the fire extinguishing device is functional even without any energy thanks to the temperature glass ampoule.

The monitoring system contains specially created software, thanks to which automatic regular internal checks of the fire extinguishing device take place and then revisions of the fire extinguishing device from the control centre.

Another system essence is the method of performing remote checks-reviews and failure reporting and wireless communication of the fire extinguishing device with the control centre. The system's electrical circuits are checked automatically using the monitoring processor.

All the results of checks and measurements are continuously signalled in the control centre, optically shown on the display of the information module or on the computer screen, and at the same time there is also a sound signal of possible failures. The results protocol is permanently available in the control centre. In accordance with the relevant standard, the report on the fire safety operability of the fire extinguishing device, containing all the measured values, is sent electronically to the operator of the protected device.

An IoT (Internet of Things) network or other similar network is used for the wireless communication between the control centre and the fire extinguishing device located in a remote closed protected space together with a protected device.

The LAN or similar network is used to check fire extinguishing devices at the place of the installation of the protected device.

Checking the loss of the connectivity of the fire extinguishing device with the temperature linear cable, which is arranged in the closed protected space and is connected to the fire extinguishing device, using a resistor connected in the circuit of the temperature linear cable as a resistance and connecting to the second evaluation unit, the measured current drop or voltage drop is evaluated and the information is transmitted to the control centre via the second wireless communication module.

Control of the decrease in the amount of extinguishing medium in the extinguishing medium carrier is carried out using a pressure sensor, which is arranged in the extinguishing medium carrier. The pressure sensor periodically verifies the pressure of the extinguishing medium in the extinguishing medium carrier. Fire extinguisher leakage is reported remotely. The pressure value of the fire extinguishing medium is sensed by the monitoring processor and this information is subsequently transmitted to the wireless communication module and transmitted to the control centre via the IoT network.

The temperature in the closed protected space is continuously measured by two independent temperature sensors, by the first temperature sensor and by the second temperature sensor. Each of these temperature sensors is able to activate the fire extinguishing device for cooling or extinguishing in the closed protected space where the protected device is located. By remote control, the difference between the temperature values of the first temperature sensor and the second temperature sensor is detected, thereby detecting a failure of one of them.

The coil of a valve, such as a solenoid valve, is monitored by a constant weak current and its failure or disconnection is remotely reported to the control centre.

Backup battery voltage is monitored and a drop below normal is remotely reported to control centre.

A failure of the external power supply and switch to the battery is remotely reported to the control centre. The door contact of the closed protected space is monitored by a door sensor, for example by an induction sensor, and the switchboard door opening is remotely reported to control centre. A position control sensor is arranged for the check of the right installation/position of the fire extinguishing device in the closed protected space.

The contact of the fire extinguishing device with the installation DIN rail is monitored by an end switch. If the contact is lost due to the system handling, such a fact is remotely reported to the control centre.

Moreover, the fire extinguishing device contains a single universal input that can be used to monitor the protected device. Terminals connected—device is all right, terminals disconnected—remotely reported error to the control centre.

Remote checks of all system parameters take place automatically and are evaluated by a professionally qualified person from the control centre. Only checking the functionality of the smoke sensor and checking the integrity of the protected space requires physical presence. Checking the connection of the smoke sensor is carried out by a regular check. The system is remotely switched over to the testing mode, the smoke sensor is activated by testing spray and the system sends a message to the control centre using the IoT network.

The fire extinguishing device connectivity check with wireless LAN connection, NB-IoT. If the fire extinguishing device does not respond to the control centre in a defined time interval using the wireless network, an error message is reported to the control centre. A LAN communication error is remotely reported to the control centre.

### EXPLANATION OF DRAWINGS/BRIEF DESCRIPTION OF THE DRAWINGS

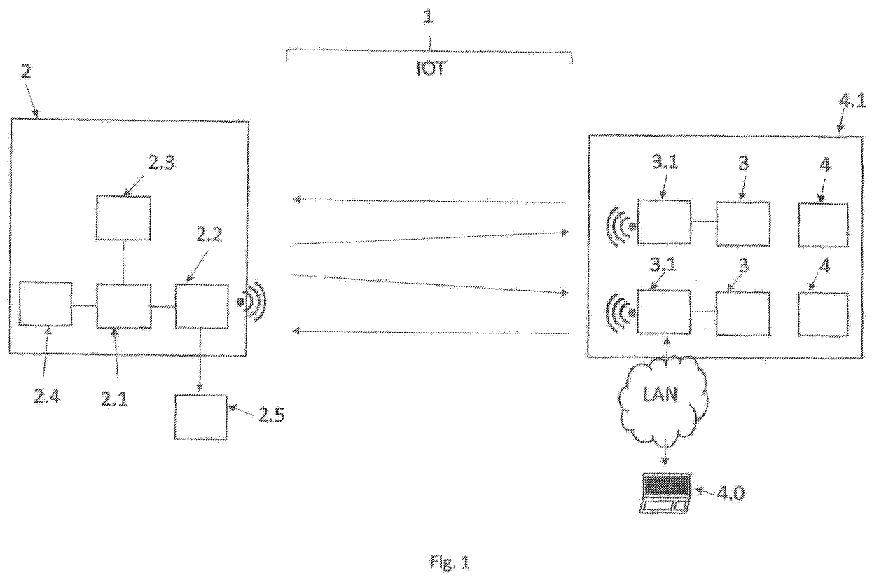

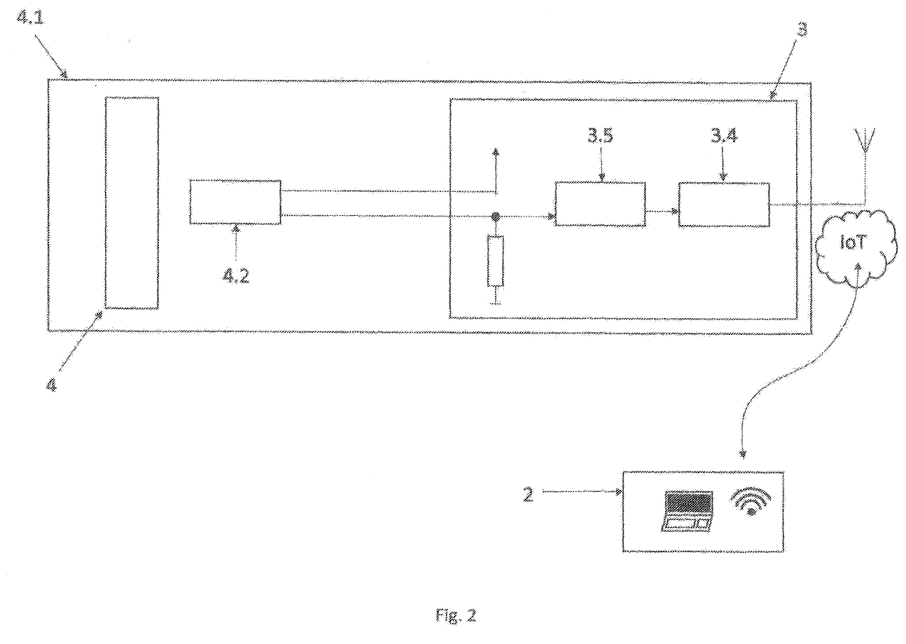

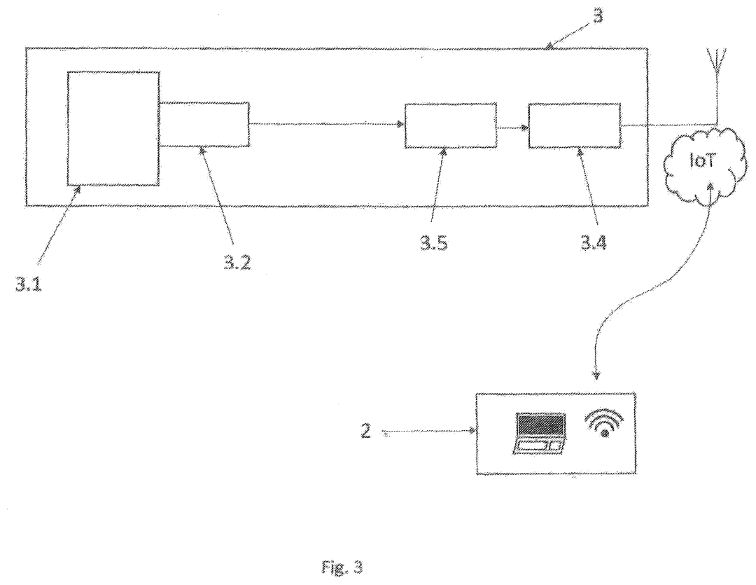

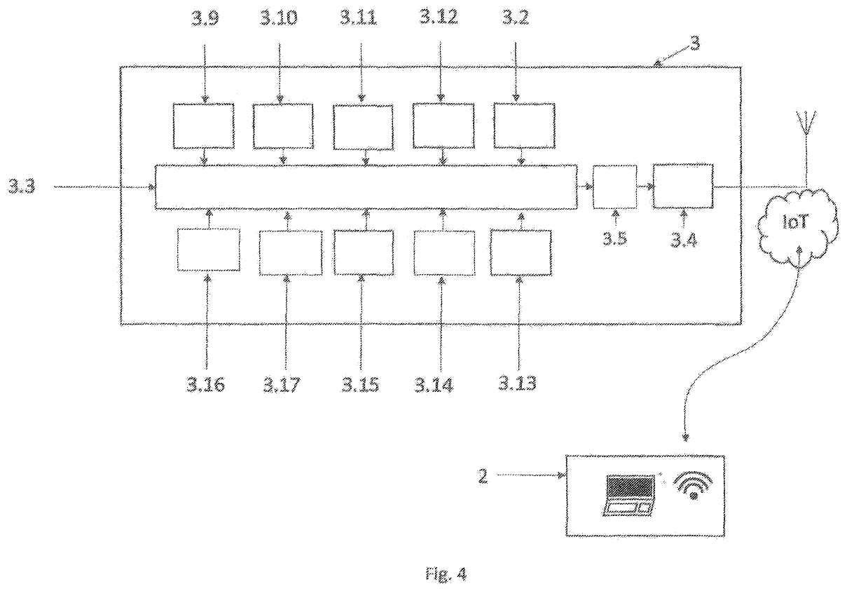

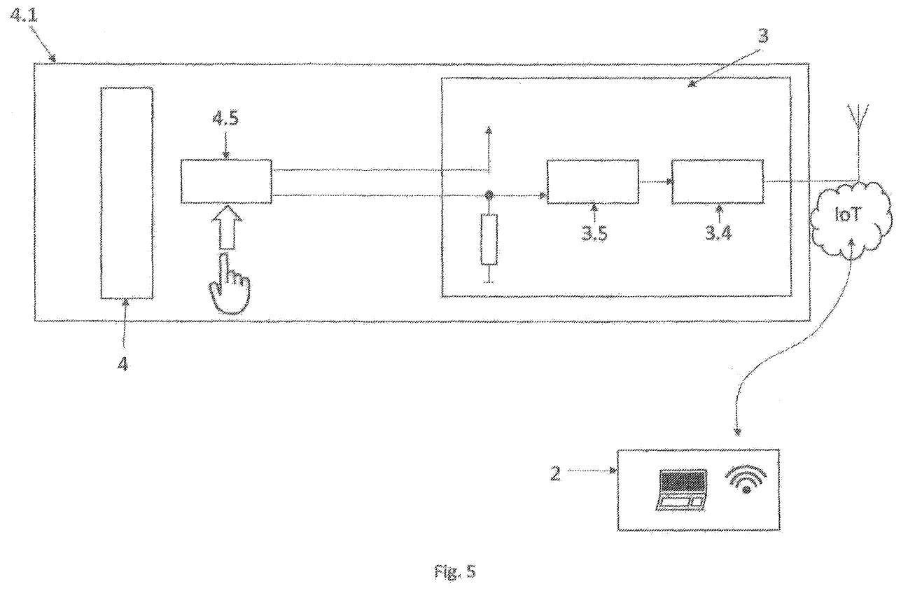

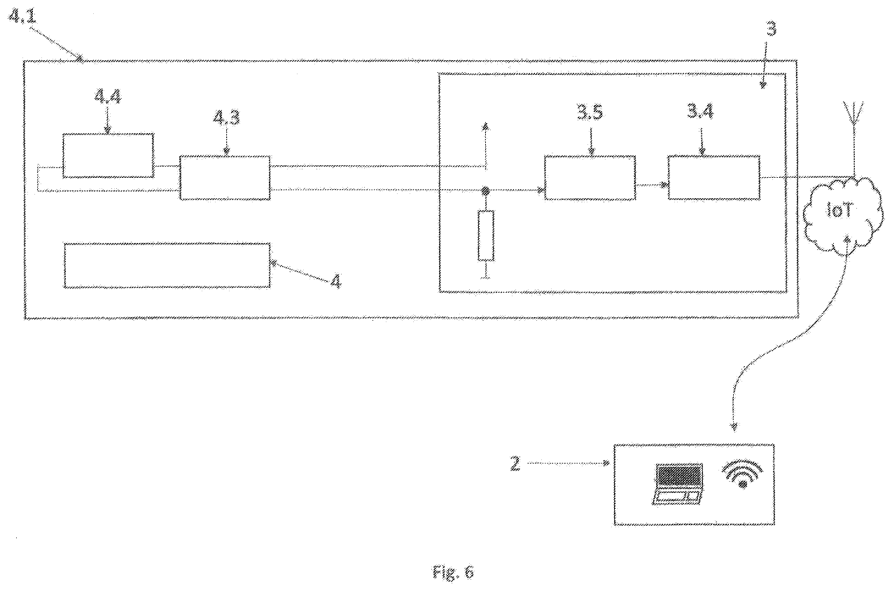

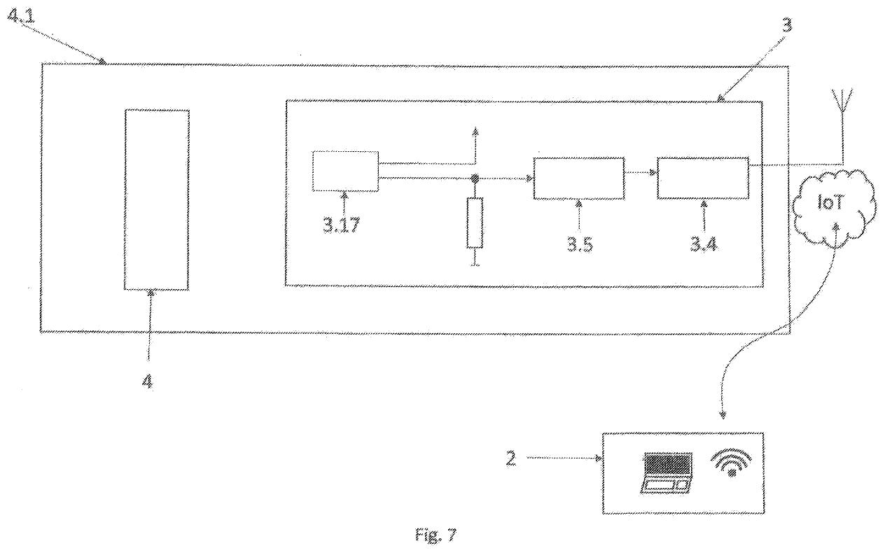

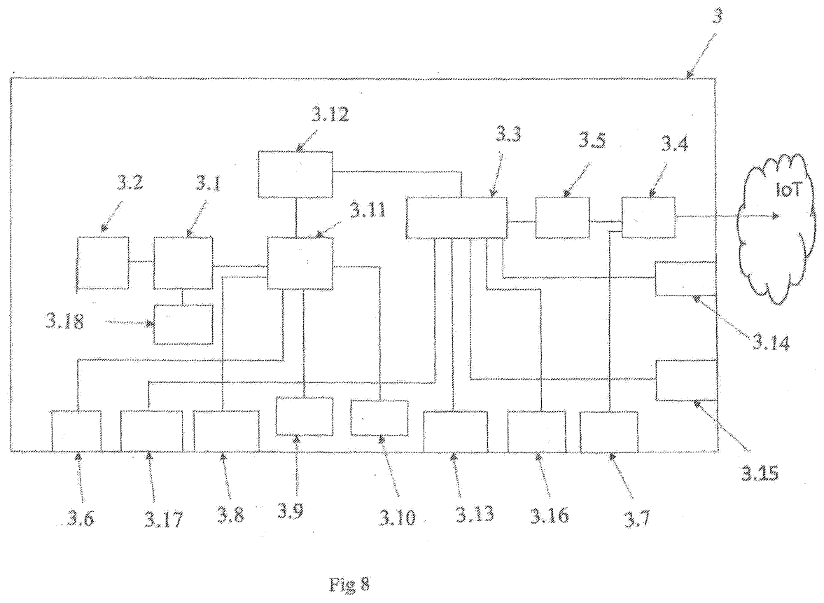

The invention is further explained in the accompanying drawings, where FIG. 1 schematically shows a block diagram of the monitoring system and wireless communication between the control centre and fire extinguishing device arranged in the closed protected space together with the protected device, FIG. 2 shows a block diagram for checking the closing of the door of the closed protected space, FIG. 3 shows a block diagram for checking the state of the extinguishing medium of the fire extinguishing device, FIG. 4 shows the check of circuits, battery, including the measurement of the voltage of the mains supply, FIG. 5 shows the physical check of the smoke sensor, FIG. 6 shows the fire extinguishing device connection check with the thermal linear cable, FIG. 7 shows the fire extinguishing device location check, and FIG. 8 is a block diagram of the fire extinguishing device.

### EXAMPLE OF INVENTION EMBODIMENT

The monitoring system 1 for the remote contactless diagnostics and control of fire extinguishing devices 3 for the local protection of protected electric devices 4, that is schematically shown on the attached figures contains the control centre 2 that contains a control unit 2.1, the first wireless communication module 2.2, the first evaluation module 2.3, the information module 2.4, further the monitoring system 1 contains two protected electric devices 4, wherein each protected electric device 4 is protected by one fire extinguishing device 3 and these two protected electric devices 4 and the above referred-to fire extinguishing devices 3 are arranged in the closed protected space 4.1—in the switchboard at remote place away from the control centre 2.

The fire extinguishing device 3 contains the extinguishing medium carrier 3.1 where the fire extinguishing medium is under pressure, where the used fire extinguishing medium is a chemical gas fire extinguisher, the fire extinguishing medium carrier 3.1 is connected to a valve, the valve is connected to a coil 3.11 of the valve, which contains a nozzle releasing the extinguishing medium from the carrier 3.1, further the fire extinguishing device 3 contains a pressure sensor 3.2 for monitoring the state of the medium in the carrier 3.1. Further the fire extinguishing device 3 contains the backup battery 3.12 and the contact 3.13 for connecting an external power supply.

The fire extinguishing device 3 further contains two temperature sensors, the first temperature sensor 3.9 and the second temperature sensor 3.10, which are arranged in the fire extinguishing device 3, both these temperature sensors continuously monitor the temperature in the closed protected space 4.1 and both of them are able to activate the fire extinguishing device 3 to extinguish/cool down the closed protected space 4.1 if the temperature rises above a given temperature, which is already undesirable, which could cause flame burning.

The fire extinguishing device 3 can be activated in order to cool down or extinguish the closed protected space 4.1 by another temperature sensor, the temperature linear cable 4.3 which is arranged in the closed protected space 4.1, where it continuously monitors the temperature. The temperature linear cable 4.3 is connected through the first contact 3.6 to the fire extinguishing device 3. While the fire extinguishing device 3 also contains elements for remote wireless control and elements for wireless communication, contains the monitoring processor 3.3, the second wireless communication module 3.4, the second evaluation unit 3.5, the fifth contact 3.17 for connecting of the position sensor monitoring the position of the fire extinguishing device 3, the end switch 3.14 checking the contact of the fire extinguishing device 3 with the DIN rail in the closed protected space 4.1, the universal input 3.15 monitoring the control unit 2.2 of the control centre 2, the LAN connector and chip 3.19, the second contact 3.8 for connecting of the smoke sensor 4.5, which is arranged in the closed protected space 4.1, the fourth contact 3.16 for connecting of the door sensor 4.2 of the closed protected space 4.1, the third contact 3.13 for connecting of the an external power supply, in order to improve the level of safety of the fire extinguishing device 3, it also contains the temperature glass ampoule 3.18 as a passive temperature sensor, which is connected to the fire extinguishing medium carrier 3.1 by being partly screwed in the carrier 3.1. The

temperature glass ampoule 3.18 is made for a certain given temperature, which is already undesirable from the point of view of safety. This temperature is 5° C. higher than the temperature set on other temperature sensors. In the case that the temperature in the closed protected space 4.1 of the protected device 4 rises to this given temperature, when none of the electronic safety elements were functional, the temperature glass ampoule 3.18 bursts and the fire extinguishing medium is released from the carrier 3.1 of the extinguishing medium into the closed protected space 4.1 and cools the temperature or extinguishes the flaming fire that arose here. Thanks to the temperature glass ampoule 3.18, the fire extinguishing device 3 is functional even without any energy.

The monitoring system 1 contains specially created software, thanks to which automatic regular internal checks of the fire extinguishing device 3 take place and then revisions of the fire extinguishing device 3 from the control centre 2.

Another essence of the system 1 is the method of performing remote checks—revisions and failure reporting and wireless communication of the fire extinguishing device 3 with the control centre 2.

The system 1 electric circuits are checked automatically by the monitoring processor 3.3 and the second evaluation unit 3.5.

All the results of checks and measurements are continuously signalled in the control centre 2 optically shown on the display of the information module 2.4 and at the same time there is also a sound signal of possible failures.

A protocol/revision report 2.5 with all results is still available in the control centre 2.

In accordance with the relevant standard, the protocol 2.5 on the fire safety operability of the fire extinguishing device 3, containing all measured values, is reported electronically to the operator 4.0 of protected device 4.

The IoT (Internet of Things) network is used for the wireless communication between the control centre 2 and the fire extinguishing device 3 located in the remote closed protected space 4.1 together with the protected device 4.

The local LAN network is used by user 4.0 to check the fire extinguishing devices 3 in the place of installation of protected devices 4 in the closed protected space 4.1.

Check of the connectivity of the fire extinguishing device 3 with the wireless connection to the LAN, NB-IoT.

If the fire extinguishing device 3 does not respond to the control centre 2 in a defined time interval, ones per day, using the wireless network NB-IoT, an error message is reported to the control centre 2.

A LAN communication error is reported to the remote control centre 2.

Checking the loss of the connectivity of the fire extinguishing device 3 with the temperature linear cable 4.3, which is arranged in the closed protected space 4.1 and is connected to the fire extinguishing device 3, with the help of the resistor 4.4 connected in the circuit of the temperature linear cable 4.3 as resistance and by connecting to the second evaluation unit 3.5 the measured current drop or voltage drop is evaluated and the information is transmitted to the control centre 2 via second wireless communication module 3.4.

Checking of the decrease in the amount of extinguishing medium in the extinguishing medium carrier 3.1 is carried out using a pressure sensor 3.2, which is arranged in the extinguishing medium carrier 3.1. The pressure sensor 3.2 periodically verifies the pressure of the extinguishing medium in the extinguishing medium carrier 3.1. Fire extinguisher leakage is reported remotely. The pressure value of the extinguishing medium is sensed by the monitoring processor 3.3 and subsequently this information is transmitted to the second wireless communication module 3.4 and via the IoT network is transmitted to the control centre 2.

The temperature in the closed protected space 4.1 is continuously measured by two independent temperature sensors, the first temperature sensor 3.9 and the second temperature sensor 3.10. Each of these temperature sensors is able to activate the fire extinguishing device 3 to cool down or extinguish flames in the closed protected space 4.1, where is located together with the protected device 4.

Difference between the temperature values of the first temperature sensor 3.9 and the second temperature sensor 3.10 is detected by remote checks and then the failure of one of them is evaluated.

The coil 3.11 of a valve with a nozzle, for example a solenoid valve, is monitored by a constant weak current, and its failure or disconnection is remotely reported to the control centre 2.

The backup battery 3.12 voltage is monitored and any drop below the normal level is remotely reported to the control centre 2.

A failure of the external power supply and the switch to the backup battery 3.12 is remotely reported to the control centre 2.

The door contact of the closed protected space 4.1 is monitored by a door sensor 4.2, for example by an induction sensor, and the opening door of the closed protected space 4.1 is remotely reported to the control centre 2.

To check the correct position of the fire extinguishing device 3 in the closed protected space 4.1, a position control sensor is arranged in the fire extinguishing device 3 using the fifth contact 3.17.

The contact of the fire extinguishing device 3 with the mounting DIN rail monitored via the end switch 3.14. The release of the fire extinguishing device 3, the case of manipulation of the fire extinguishing device 3 is remotely reported to the control centre 2.

Moreover, the fire extinguishing device 3 contains a single universal input 3.15 that can be used to monitor the protected device 4. Terminals connected—protected device (4) is all right, terminals disconnected—remotely reported error to the control centre 2.

Remote checks of all system parameters take place automatically and are evaluated by a professionally qualified person from the control centre 2. Only checking the functionality of the smoke sensor 4.5 and checking the integrity of the closed protected space 4.1 requires physical presence. Checking the connection of the smoke sensor 4.5 is carried out by a regular check. The system 1 is remotely switched over to the testing mode, the smoke sensor 4.5 is activated by testing spray and the result is transmitted to the control centre 2 using the IoT network.

### INDUSTRIAL APPLICABILITY

The monitoring system for remote non-contact diagnostics and control of automatic fire extinguishing devices for local protection of electrical devices can be used for the protection of electrical switchboards, in LV (low voltage) disconnection boxes, in master house boxes, in electricity meter switchboards, in distribution cores, in the main electrical distribution of apartment buildings, in switchboards family houses, in switchboards of industrial and commercial premises, in installation boxes of sockets and switches, for the protection of electronics, machines and equipment, CNC machines, lasers, production lines, for the protection of computing and data technology, rack cabinets, PC cabinets, servers, electrical switchboards also for the protection of electrical equipment used in public productions, for the protection of lighting technology, sources of large-screen screens, also for the protection of connectors, industrial connectors, for the protection of batteries, backup batteries, batteries for driving electric motors, electric cars, and the like.

### Reference Marks

1—Monitoring system for remote contactless diagnostics and control of automatic fire devices for local protection of electrical devices
2—Control centre
2.1—Control unit
2.2—The first wireless communication module
2.3—The first evaluation module
2.4—Information module
2.5—Output protocol—revision report
3—Automatic cooling and fire extinguishing device, further fire extinguishing device
3.1—Medium carrier
3.2—Pressure sensor—for monitoring the state of the medium
3.3—Monitoring processor
3.4—The second wireless communication module
3.5—The second evaluation unit
3.6—The first contact for connecting of the temperature linear cable
3.7—LAN connector and chip
3.8—The second contact for connecting the smoke sensor
3.9—The first temperature sensor
3.10—The second temperature sensor
3.11—Coil (of the valve with the nozzle)
3.12—Backup battery
3.13—The third contact for connecting an external power supply
3.14—End switch—for checking the contact of the fire extinguishing device with the DIN rail
3.15—Universal input—for monitoring the control unit—control centre
3.16—The fourth contact for connecting of the door sensor of the closed protected space
3.17—The fifth contact for connecting of the position sensor of the fire extinguishing device
3.18—Temperature glass ampoule as another temperature sensor—the second safety way
4. Protected device especially the electrical switchboard
4.0—User of the protected device
4.1—Closed protected space
4.2—Door sensor of the closed protected space
4.3—Temperature linear cable as a temperature sensor
4.4—Resistor—to measure the correct connection of the temperature linear cable
4.5—Smoke sensor

1. The monitoring system for remote contactless diagnostics and control of automatic fire extinguishing devices for local protection of electrical devices characterized in that it contains the control center (2), at least one fire extinguishing device (3) arranged remotely together with at least one protected device (4) in the closed protected space (4.1) wherein at each protected device (4) at least one fire extinguishing device (3) is arranged, wherein the IoT type network or similar network is used for the wireless communication between the control center (2) and at least one fire extinguishing device (3) arranged in the remote closed protected space (4.1) together with the protected device (4) and LAN connection or a similar network or GSM is used for the communication between at least one fire extinguishing device (3) arranged in the closed protected space (4.1) together with the protected device (4) and user (4.0) of the protected device (4).

1. The monitoring system according to the claim 1 characterized in that the control center (2) contains the control unit (2.1) that is connected with the first wireless communication module (2.2), with the first evaluation module (2.3) and with the information module (2.4), wherein the first module (2.2) for wireless communication is technically equipped for the use of the IoT network or a similar network, but also for the electronic sending of protocols (2.5) about the operability of the fire extinguishing device (3).

3. The monitoring system according to the claim 1 where the fire extinguishing device (3) contains the extinguishing medium carrier (3.1) in which the gas fire extinguishing medium is under pressure, the extinguishing medium carrier (3.1) is directly connected to the valve which contains a nozzle to release extinguishing medium from the carrier (3.1) to the closed protected space (4.1), further the fire extinguishing device (3) contains the pressure sensor (3.2) for detecting the state of the medium in the carrier (3.1), the third contact (3.13) for connecting an external power supply, the first temperature sensor (3.9), the second temperature sensor (3.10), that automatically monitors the temperature in the closed protected space (4.1) of the protected device (4), further the fire extinguishing device (3) also contains the backup battery (3.12) to which the coil (3.11) of the valve with a nozzle is connected, the coil is connected to the first temperature sensor (3.9) and to the second temperature sensor (3.10) characterized in that the fire extinguishing device (3) father contains the monitoring processor (3.3), which is connected to the second evaluation unit (3.5), the second evaluation unit (3.5) is connected with the second wireless communication module (3.4), the monitoring processor (3.3) is connected to the fifth contact (3.17) for the connecting of the position sensor of the fire extinguishing device (3), further with the fourth contact (3.16) for the connecting of the door sensor of the closed protected space (4.1), further with the universal input (3.15) for the monitoring of the control unit (2.1) of the control center (2), further with the end switch (3.14) for checking the contact of the fire extinguishing device (3) with the DIN rail, further the fire extinguishing device (3) contains the first contact (3.6) for connecting of the temperature linear cable (4.3) which is connected with the coil (3.11) of the valve with the nozzle, wherein the temperature linear cable (4.3) is arranged in the closed protected space (4.1), the coil (3.11) of the valve with the nozzle is connected to the second contact (3.8) for connecting of the smoke sensor (4.5), which is arranged in the closed protected space (4.1), the coil (3.11) is further connected to the first temperature sensor (3.9) and the second temperature sensor (3.10), further the fire extinguishing device (3) is connected with the connector (3.7) for the LAN chip, in order to improve the safety, the fire extinguishing device (3) further contains a temperature glass ampoule (3.18) as a passive temperature sensor, which is connected to the extinguishing medium carrier (3.1) in such a way that it is partially embedded in the carrier, for example screwed, the fire extinguishing device (3) shows, thanks to the temperature glass ampoule (3.18), an extinguishing function even without any energy (discharged battery, non-functional wireless communication.

4. The method of the remote contactless diagnostics and control of automatic fire extinguishing devices (3) for the local protection of electrical devices according to the claim 1 characterized in that the method takes place in the following steps:
checking the connectivity of the fire extinguishing device (3) with the wireless connection of the LAN, NB-IoT takes place in such a way if the fire extinguishing device (3) does not respond in the defined time interval to the control center (2) using the wireless network LAN NB-IoT, an error message is reported to the control center (2)
checking of the electrical circuits of the system takes place automatically using the monitoring processor (3.3)
checking the loss of the connectivity of the fire extinguishing device (3) with the temperature linear cable (4.3), which is arranged in the closed protected space (4.1) and is connected to the fire extinguishing device (3), with the help of the resistor (4.4) connected in the circuit of the temperature linear cable (4.3) as resistance and by connecting to the second evaluation unit (3.5) the measured current drop or voltage drop is evaluated and the second wireless communication module (3.4) transmits the information to the control center (2)
checking of the decrease in the amount of extinguishing medium in the extinguishing medium carrier (3.1) is carried out using a pressure sensor (3.2), which is arranged in the extinguishing medium carrier (3.1), wherein the pressure sensor (3.2) periodically verifies the pressure of the extinguishing medium in the extinguishing medium carrier (3.1), the pressure value of the extinguishing medium is sensed by the monitoring processor (3.3) and subsequently this information is transmitted to the second wireless communication module (3.4) and via the IoT network is transmitted to the control center (2) if the leakage of the extinguishing medium is detected
the temperature in the closed protected space (4.1) is continuously measured by two independent temperature sensors, by the first temperature sensor (3.9) and by the second temperature sensor (3.10), wherein the difference between the temperature values of the first temperature sensor (3.9) and the second temperature sensor (3.10) is detected by remote checks and then the failure of one of them is evaluated and the failure is reported to the control center (2),
The coil (3.11) of the valve with a nozzle, for example a solenoid valve, is monitored by a constant weak current, and its failure or disconnection is remotely reported to the control center (2),
The backup battery (3.12) voltage is monitored by the monitoring processor (3.3) and any drop below the normal level is remotely reported to the control center (2),
The failure of the external power supply is monitored by the monitoring processor (3.3) via the third contact (3.13) for connecting the external power supply, and the transition to the backup battery (3.12) is remotely reported to the control center (2),
The door contact of the closed protected space (4.1) is monitored by a door sensor (4.2), for example by an induction sensor, and the opening of the door of the closed protected space (4.1) is remotely reported to the control center (2),
To check the correct position of the fire extinguishing device (3) in the closed protected space (4.1), a position control sensor is arranged in the fire extinguishing device (3) using the fifth contact (3.17), the result is reported to the control center (2),
the contact of the fire extinguishing device (3) with the mounting DIN rail in the closed protected space (4.1) is monitored via the end switch (3.14), the release of the fire extinguishing device (3), the case of manipulation of the fire extinguishing device (3) is remotely reported to the control center (2),
The protected device (4) can be monitored through the universal input (3.15), Terminals connected-protected device (4) is all right, terminals disconnected-remotely reported error to the control center (2),
checking the functionality of the smoke sensor (4.5) and checking the integrity of the closed protected space (4.1) requires physical presence, checking the connection of the smoke sensor (4.5) is carried out by a regular check, the system (1) switches remotely from the control center (2),
(2) to the testing mode, the activation of the smoke sensor (4.5) is performed by the test spray and the result is reported via the IoT network to the control center (2),
all the results of checks and measurements are continuously signaled in the control center (2)—optically shown on the display of the information module (2.4) and at the same time there is also a sound signal of possible failures,
a protocol/revision report (2.5) with all results is still available in the control center(2), and, in accordance with the relevant standard, the protocol (2.5) on the fire safety operability of the fire extinguishing device (3), containing all measured values, is reported electronically to the operator (4.0) of protected device.

5. The monitoring system according to the claim 2 where the fire extinguishing device (3) contains the extinguishing medium carrier (3.1) in which the gas fire extinguishing medium is under pressure, the extinguishing medium carrier (3.1) is directly connected to the valve which contains a nozzle to release extinguishing medium from the carrier (3.1) to the closed protected space (4.1), further the fire extinguishing device (3) contains the pressure sensor (3.2) for detecting the state of the medium in the carrier (3.1), the third contact (3.13) for connecting an external power supply, the first temperature sensor (3.9), the second temperature sensor (3.10), that automatically monitors the temperature in the closed protected space (4.1) of the protected device (4), further the fire extinguishing device (3) also contains the backup battery (3.12) to which the coil (3.11) of the valve with a nozzle is connected, the coil is connected to the first temperature sensor (3.9) and to the second temperature sensor (3.10) characterized in that the fire extinguishing device (3) father contains the monitoring processor (3.3), which is connected to the second evaluation unit (3.5), the second evaluation unit (3.5) is connected with the second wireless communication module (3.4), the monitoring processor (3.3) is connected to the fifth contact (3.17) for the connecting of the position sensor of the fire extinguishing device (3), further with the fourth contact (3.16) for the connecting of the door sensor of the closed protected space (4.1), further with the universal input (3.15) for the monitoring of the control unit (2.1) of the control center (2), further with the end switch (3.14) for checking the contact of the fire extinguishing device (3) with the DIN rail, further the fire extinguishing device (3) contains the first contact (3.6) for connecting of the temperature linear cable (4.3) which is connected with the coil (3.11) of the valve with the nozzle, wherein the temperature linear cable (4.3) is arranged in the closed protected space (4.1), the coil (3.11) of the valve with the nozzle is connected to the second contact (3.8) for connecting of the smoke sensor (4.5), which is arranged in the closed protected space (4.1), the coil (3.11) is further connected to the first temperature sensor (3.9) and the second temperature sensor (3.10), further the fire extinguishing device (3) is connected with the connector (3.7) for the LAN chip, in order to improve the safety, the fire extinguishing device (3) further contains a temperature glass ampoule (3.18) as a passive temperature sensor, which is connected to the extinguishing medium carrier (3.1) in such a way that it is partially embedded in the carrier, for example screwed, the fire extinguishing device (3) shows, thanks to the temperature glass ampoule (3.18), an extinguishing function even without any energy (discharged battery, non-functional wireless communication.

6. The method of the remote contactless diagnostics and control of automatic fire extinguishing devices (3) for the local protection of electrical devices according to the claim 2 characterized in that the method takes place in the following steps:
checking the connectivity of the fire extinguishing device (3) with the wireless connection of the LAN, NB-IoT takes place in such a way if the fire extinguishing device (3) does not respond in the defined time interval to the control center (2) using the wireless network LAN NB-IoT, an error message is reported to the control center (2)
checking of the electrical circuits of the system takes place automatically using the monitoring processor (3.3)
checking the loss of the connectivity of the fire extinguishing device (3) with the temperature linear cable (4.3), which is arranged in the closed protected space (4.1) and is connected to the fire extinguishing device (3), with the help of the resistor (4.4) connected in the circuit of the temperature linear cable (4.3) as resistance and by connecting to the second evaluation unit (3.5) the measured current drop or voltage drop is evaluated and the second wireless communication module (3.4) transmits the information to the control center (2)
checking of the decrease in the amount of extinguishing medium in the extinguishing medium carrier (3.1) is carried out using a pressure sensor (3.2), which is arranged in the extinguishing medium carrier (3.1), wherein the pressure sensor (3.2) periodically verifies the pressure of the extinguishing medium in the extinguishing medium carrier (3.1), the pressure value of the extinguishing medium is sensed by the monitoring processor (3.3) and subsequently this information is transmitted to the second wireless communication module (3.4) and via the IoT network is transmitted to the control center (2) if the leakage of the extinguishing medium is detected
the temperature in the closed protected space (4.1) is continuously measured by two independent temperature sensors, by the first temperature sensor (3.9) and by the second temperature sensor (3.10), wherein the difference between the temperature values of the first temperature sensor (3.9) and the second temperature sensor (3.10) is detected by remote checks and then the failure of one of them is evaluated and the failure is reported to the control center (2),
The coil (3.11) of the valve with a nozzle, for example a solenoid valve, is monitored by a constant weak current, and its failure or disconnection is remotely reported to the control center (2),
The backup battery (3.12) voltage is monitored by the monitoring processor (3.3) and any drop below the normal level is remotely reported to the control center (2),
The failure of the external power supply is monitored by the monitoring processor (3.3) via the third contact (3.13) for connecting the external power supply, and the transition to the backup battery (3.12) is remotely reported to the control center (2),
The door contact of the closed protected space (4.1) is monitored by a door sensor (4.2), for example by an induction sensor, and the opening of the door of the closed protected space (4.1) is remotely reported to the control center (2)
To check the correct position of the fire extinguishing device (3) in the closed protected space (4.1), a position control sensor is arranged in the fire extinguishing device (3) using the fifth contact (3.17), the result is reported to the control center (2),
the contact of the fire extinguishing device (3) with the mounting DIN rail in the closed protected space (4.1) is monitored via the end switch (3.14), the release of the fire extinguishing device (3), the case of manipulation of the fire extinguishing device (3) is remotely reported to the control center (2),
The protected device (4) can be monitored through the universal input (3.15), Terminals connected—protected device (4) is all right, terminals disconnected-remotely reported error to the control center (2),
checking the functionality of the smoke sensor (4.5) and checking the integrity of the closed protected space (4.1) requires physical presence, checking the connection of the smoke sensor (4.5) is carried out by a regular check, the system (1) switches remotely from the control center (2),
(2) to the testing mode, the activation of the smoke sensor (4.5) is performed by the test spray and the result is reported via the IoT network to the control center (2),
all the results of checks and measurements are continuously signaled in the control center (2)—optically shown on the display of the information module (2.4) and at the same time there is also a sound signal of possible failures,
a protocol/revision report (2.5) with all results is still available in the control center (2), and, in accordance with the relevant standard, the protocol (2.5) on the fire safety operability of the fire extinguishing device (3), containing all measured values, is reported electronically to the operator (4.0) of protected device.

7. The method of the remote contactless diagnostics and control of automatic fire extinguishing devices (3) for the local protection of electrical devices according to the claim 3 characterized in that the method takes place in the following steps:
checking the connectivity of the fire extinguishing device (3) with the wireless connection of the LAN, NB-IoT takes place in such a way if the fire extinguishing device (3) does not respond in the defined time interval to the control center (2) using the wireless network LAN NB-IoT, an error message is reported to the control center (2)
checking of the electrical circuits of the system takes place automatically using the monitoring processor (3.3)
checking the loss of the connectivity of the fire extinguishing device (3) with the temperature linear cable (4.3), which is arranged in the closed protected space (4.1) and is connected to the fire extinguishing device (3), with the help of the resistor (4.4) connected in the circuit of the temperature linear cable (4.3) as resistance and by connecting to the second evaluation unit (3.5) the measured current drop or voltage drop is evaluated and the second wireless communication module (3.4) transmits the information to the control center (2)
checking of the decrease in the amount of extinguishing medium in the extinguishing medium carrier (3.1) is carried out using a pressure sensor (3.2), which is arranged in the extinguishing medium carrier (3.1), wherein the pressure sensor (3.2) periodically verifies the pressure of the extinguishing medium in the extinguishing medium carrier (3.1), the pressure value of the extinguishing medium is sensed by the monitoring processor (3.3) and subsequently this information is transmitted to the second wireless communication module (3.4) and via the IoT network is transmitted to the control center (2) if the leakage of the extinguishing medium is detected
the temperature in the closed protected space (4.1) is continuously measured by two independent temperature sensors, by the first temperature sensor (3.9) and by the second temperature sensor (3.10), wherein the difference between the temperature values of the first temperature sensor (3.9) and the second temperature sensor (3.10) is detected by remote checks and then the failure of one of them is evaluated and the failure is reported to the control center (2),
The coil (3.11) of the valve with a nozzle, for example a solenoid valve, is monitored by a constant weak current, and its failure or disconnection is remotely reported to the control center (2),
The backup battery (3.12) voltage is monitored by the monitoring processor (3.3) and any drop below the normal level is remotely reported to the control center (2),
The failure of the external power supply is monitored by the monitoring processor (3.3) via the third contact (3.13) for connecting the external power supply, and the transition to the backup battery (3.12) is remotely reported to the control center (2),
The door contact of the closed protected space (4.1) is monitored by a door sensor (4.2), for example by an induction sensor, and the opening of the door of the closed protected space (4.1) is remotely reported to the control center (2),
To check the correct position of the fire extinguishing device (3) in the closed protected space (4.1), a position control sensor is arranged in the fire extinguishing device (3) using the fifth contact (3.17), the result is reported to the control center (2),
the contact of the fire extinguishing device (3) with the mounting DIN rail in the closed protected space (4.1) is monitored via the end switch (3.14), the release of the fire extinguishing device (3), the case of manipulation of the fire extinguishing device (3) is remotely reported to the control center (2),
The protected device (4) can be monitored through the universal input (3.15), Terminals connected—protected device (4) is all right, terminals disconnected—remotely reported error to the control center (2),
checking the functionality of the smoke sensor (4.5) and checking the integrity of the closed protected space (4.1) requires physical presence, checking the connection of the smoke sensor (4.5) is carried out by a regular check, the system (1) switches remotely from the control center (2),
(2) to the testing mode, the activation of the smoke sensor (4.5) is performed by the test spray and the result is reported via the IoT network to the control center (2),
all the results of checks and measurements are continuously signaled in the control center (2)—optically shown on the display of the information module (2.4) and at the same time there is also a sound signal of possible failures,
a protocol/revision report (2.5) with all results is still available in the control center (2), and, in accordance with the relevant standard, the protocol (2.5) on the fire safety operability of the fire extinguishing device (3), containing all measured values, is reported electronically to the operator (4.0) of protected device.

8. The method of the remote contactless diagnostics and control of automatic fire extinguishing devices (3) for the local protection of electrical devices according to the claim 5 characterized in that the method takes place in the following steps:
checking the connectivity of the fire extinguishing device (3) with the wireless connection of the LAN, NB-IoT takes place in such a way if the fire extinguishing device (3) does not respond in the defined time interval to the control center (2) using the wireless network LAN NB-IoT, an error message is reported to the control center (2)
checking of the electrical circuits of the system takes place automatically using the monitoring processor (3.3)
checking the loss of the connectivity of the fire extinguishing device (3) with the temperature linear cable (4.3), which is arranged in the closed protected space (4.1) and is connected to the fire extinguishing device (3), with the help of the resistor (4.4) connected in the circuit of the temperature linear cable (4.3) as resistance and by connecting to the second evaluation unit (3.5) the measured current drop or voltage drop is evaluated and the second wireless communication module (3.4) transmits the information to the control center (2)
checking of the decrease in the amount of extinguishing medium in the extinguishing medium carrier (3.1) is carried out using a pressure sensor (3.2), which is arranged in the extinguishing medium carrier (3.1), wherein the pressure sensor (3.2) periodically verifies the pressure of the extinguishing medium in the extinguishing medium carrier (3.1), the pressure value of the extinguishing medium is sensed by the monitoring processor (3.3) and subsequently this information is: transmitted to the second wireless communication module (3.4) and via the IoT network is transmitted to the control center (2) if the leakage of the extinguishing medium is detected
the temperature in the closed protected space (4.1) is continuously measured by two independent temperature sensors, by the first temperature sensor (3.9) and by the second temperature sensor (3.10), wherein the difference between the temperature values of the first temperature sensor (3.9) and the second temperature sensor (3.10) is detected by remote checks and then the failure of one of them is evaluated and the failure is reported to the control center (2),
The coil (3.11) of the valve with a nozzle, for example a solenoid valve, is monitored by a constant weak current, and its failure or disconnection is remotely reported to the control center (2),
The backup battery (3.12) voltage is monitored by the monitoring processor (3.3) and any drop below the normal level is remotely reported to the control center (2),
The failure of the external power supply is monitored by the monitoring processor (3.3) via the third contact (3.13) for connecting the external power supply, and the transition to the backup battery (3.12) is remotely reported to the control center (2),
The door contact of the closed protected space (4.1) is monitored by a door sensor (4.2), for example by an induction sensor, and the opening of the door of the closed protected space (4.1) is remotely reported to the control center (2)
To check the correct position of the fire extinguishing device (3) in the closed protected space (4.1), a position control sensor is arranged in the fire extinguishing device (3) using the fifth contact (3.17), the result is reported to the control center (2),
the contact of the fire extinguishing device (3) with the mounting DIN rail in the closed protected space (4.1) is monitored via the end switch (3.14), the release of the fire extinguishing device (3), the case of manipulation of the fire extinguishing device (3) is remotely reported to the control center (2),
The protected device (4) can be monitored through the universal input (3.15), Terminals connected—protected device (4) is all right, terminals disconnected—remotely reported error to the control center (2),
checking the functionality of the smoke sensor (4.5) and checking the integrity of the closed protected space (4.1) requires physical presence, checking the connection of the smoke sensor (4.5) is carried out by a regular check, the system (1) switches remotely from the control center (2),
(2) to the testing mode, the activation of the smoke sensor (4.5) is performed by the test spray and the result is reported via the IoT network to the control center (2),
all the results of checks and measurements are continuously signaled in the control center (2)—optically shown on the display of the information module (2.4) and at the same time there is also a sound signal of possible failures,
a protocol/revision report (2.5) with all results is still available in the control center (2), and, in accordance with the relevant standard, the protocol (2.5) on the fire safety operability of the fire extinguishing device (3), containing all measured values, is reported electronically to the operator (4.0) of protected device.
